(19) United States
(12) Patent Application Publication
(10) Pub. No.: US 2011/0277387 A1
(43) Pub. Date: Nov. 17, 2011

(54) WINDOW DISPLACEMENT ASSEMBLY

(76) Inventor: Willi Ohmenzetter, St Marys (AU)

(21) Appl. No.: 13/103,610

(22) Filed: May 9, 2011

(30) Foreign Application Priority Data
May 12, 2010 (AU) 2010902043

(51) Int. Cl. E06B 7/00; E05D 15/56

(52) U.S. Cl. 49/506; 49/148

(57) ABSTRACT

A window displacement assembly (11) to displace a window sash (5) from a window frame (16), the frame (6) having a pair of parallel vertically extending jambs (7) spaced apart by a horizontally extending lintel (8) and a horizontally extending sill (9) to define a generally rectangular window frame. The assembly including a housing (12) located adjacent said lintel (8); a shaft (14) to extend away from said housing and parallel to said lintel and a top of said window sash; a first arm (15) pivotally connected at a fixed end (16) to said shaft adjacent said housing; a second arm (17) pivotally connected at a fixed end (18) to said shaft remote said housing. Each arm being located substantially adjacent a separate jamb and having a free end (20), each said free end having a portion (21) engageable with a corresponding guide (25) formed in vertical sides of said sash. A cord (26) to rotate said shaft; whereby in use rotation of said shaft moves said free ends of said arms within said guides to urge said top of said sash to move away from said lintel to disengage said sash from said frame to provide access to both sides of a window pane located within the sash.

### CROSS-REFERENCE TO RELATED APPLICATION

This application claims priority to Australian Patent Application No. 2010902043, filed May 12, 2010.

### FIELD OF THE INVENTION

The present invention relates to a window assembly and in particular to, an assembly to displace an inner window frame (or sash) from an outer window frame (having vertical jambs, a top horizontal lintel and a bottom horizontal sill).

### BACKGROUND OF THE INVENTION

It is common for buildings and other such structures to include windows, sky lights, apertures and the like to provide means for light and air to enter and exit the structure. In the most common cases of a building or house, fixed or moveable windows are installed. A window assembly typically includes an inner frame (or sash) and an outer window frame (having vertical jambs, a top horizontal lintel and a bottom horizontal sill) usually made of timber or metal separating the window from the wall of the structure. The jamb can include tracks or the like to allow the inner window frame to slide or move. The jamb typically connects to the sash which is usually wooden or metal and encases the glass pane. It will however be appreciated that the invention is not limited to these features and is also suitable for other types of windows or apertures.

Typical fixed windows have several disadvantages including that they are difficult to clean especially when installed on high rise buildings or windows well above ground level. It would be advantageous to provide a window where the outside of the window pane can be cleaned from the inside of the structure more easily. Currently, complicated window cleaning equipment including cranes and the like or the use of window cleaners hanging from dangerous ropes are required to clean the outside window panes of high rise buildings. Even in a house with sliding windows, it is difficult to completely clean the outside of the window while leaning out the window with possible consequences of falling and missing spots.

### OBJECT OF THE INVENTION

It is the object of the present invention to substantially overcome or at least ameliorate one or more of the above disadvantages as to provide a useful alternative.

### BRIEF SUMMARY OF THE INVENTION

There is disclosed herein a window displacement assembly to displace a window sash from a window frame, the frame having a pair of parallel vertically extending jambs spaced apart by a horizontally extending lintel and a horizontally extending sill to define a generally rectangular window frame; said assembly including:

a housing located adjacent said lintel;

a shaft to extend away from said housing and parallel to said lintel and a top of said window sash;

a first arm pivotally connected at a fixed end to said shaft adjacent said housing;

a second arm pivotally connected at a fixed end to said shaft remote said housing;

each arm being located substantially adjacent a separate jamb and having a free end, each said free end having a portion engageable with a corresponding guide formed in vertical sides of said sash;

means to rotate said shaft;

whereby in use rotation of said shaft moves said free ends of said arms within said guides to urge said top of said sash to move away from said lintel to disengage said sash from said frame to provide access to both sides of a window pane located within the sash.

Preferably, said shaft is a first shaft and wherein said means includes a second shaft locatable perpendicular to said first shaft and operatively associated therewith to rotate said first shaft upon movement of said second shaft.

Preferably, said rotation means includes a cord extending from said housing which when urged by a user rotates said second shaft.

Preferably, said housing is located within one said jamb.

Preferably, said guides are longitudinal slots that extend along a length of said sides of said sash.

Preferably, the sash surrounds a pane of glass.

Preferably, including motor means to rotate said second shaft.

Preferably, said portions of said arms are rivets.

Preferably, in use said arms are urged from a position parallel to said respective jambs to a position substantially perpendicular to said jambs.

There is further disclosed herein a method of displacing a window sash from a window frame, the window frame having a pair of parallel vertically extending jambs spaced apart by a horizontally extending lintel and a horizontally extending sill to define a generally rectangular window frame, the method including the steps of:

a user pulling a cord to rotate a shaft located adjacent said lintel;

said shaft upon rotation moving a pair of arms between a first position where said aims are substantially parallel to said jamb and a second position where said arms are substantially perpendicular to said jamb;

movement of said arms between said first and second positions urges protrusions located at a free end of said aims along slots located in said sash to move a top portion of said sash away from said lintel and out of engagement with said frame to provide a user access to both sides of a window pane located within said sash.

### BRIEF DESCRIPTION OF THE DRAWINGS

A preferred embodiment of the present invention will now be described, by way of an example only, with reference to the accompanying drawings wherein:

FIG. 1 is a perspective view of an embodiment of the displacement mechanism of the present invention;

FIG. 2 is another perspective view of the displacement mechanism illustrated in FIG. 1;

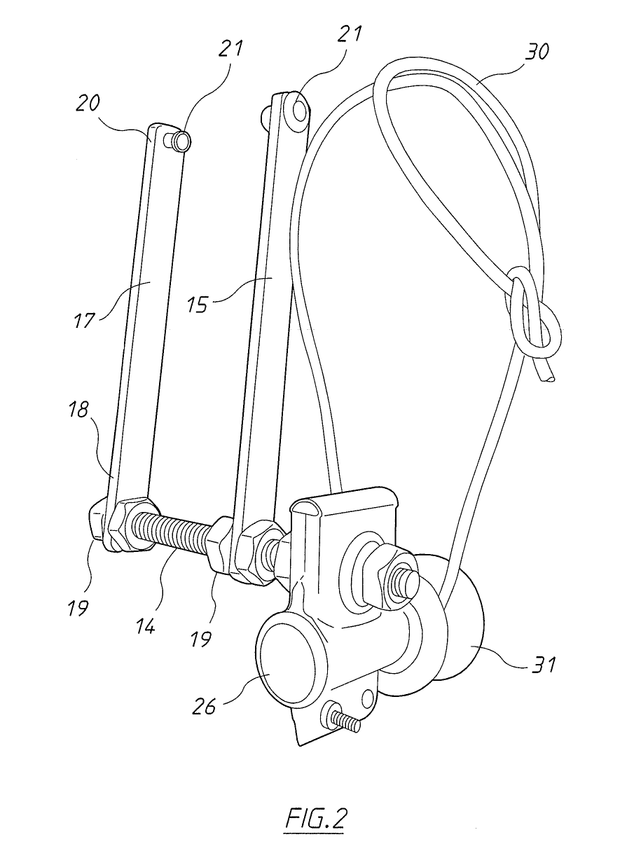

FIG. 3 is a side view of the displacement mechanism illustrated in FIG. 1;

FIG. 4 shows an embodiment of the invention showing the window sash in the open configuration;

FIG. 5 shows the sash of an embodiment of the invention moving from the open to the closed position; and

FIG. 6 shows the sash of an embodiment of the invention in the closed position.

### DETAILED DESCRIPTION OF THE INVENTION

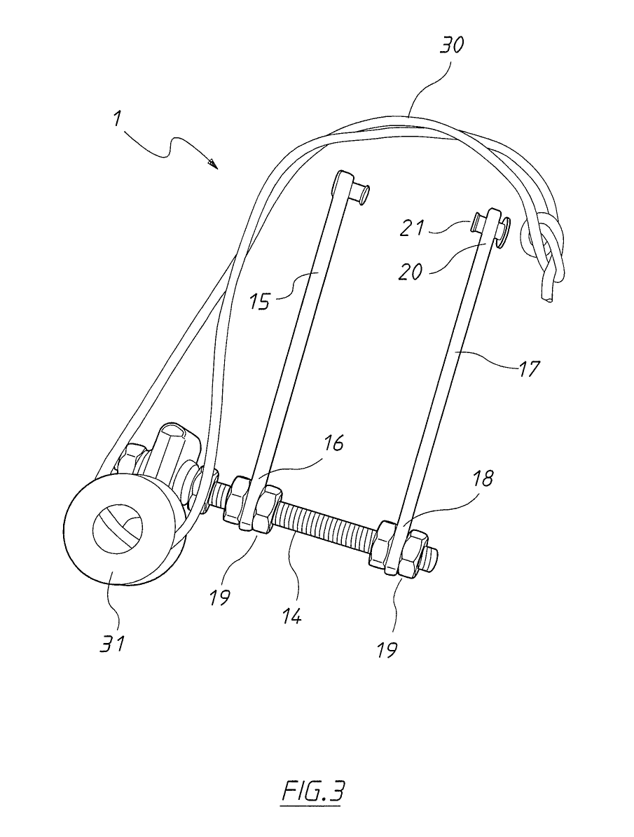

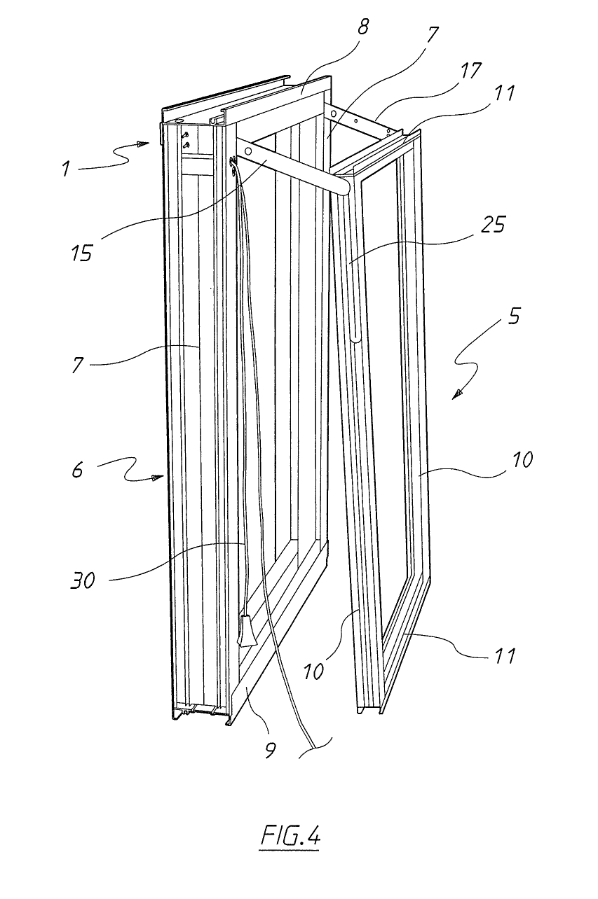

Referring to the drawings and in particular to FIGS. 3 and 4, there is disclosed a window displacement assembly 1 to displace a window sash 5 holding a glass pane (not shown) from a window frame 6. The window frame 6 includes a pair of parallel vertically extending jambs 7 spaced apart by a horizontally extending member for example a extending jambs 7 spaced apart by a horizontally extending member for example a lintel 8 at the top and a horizontally extending member for example a sill 9 at the bottom to define a generally rectangular window frame 6. The sash 5 is also typically of a generally rectangular shape and includes a pair of vertically extending sides 10 spaced apart by top and bottom members 11.

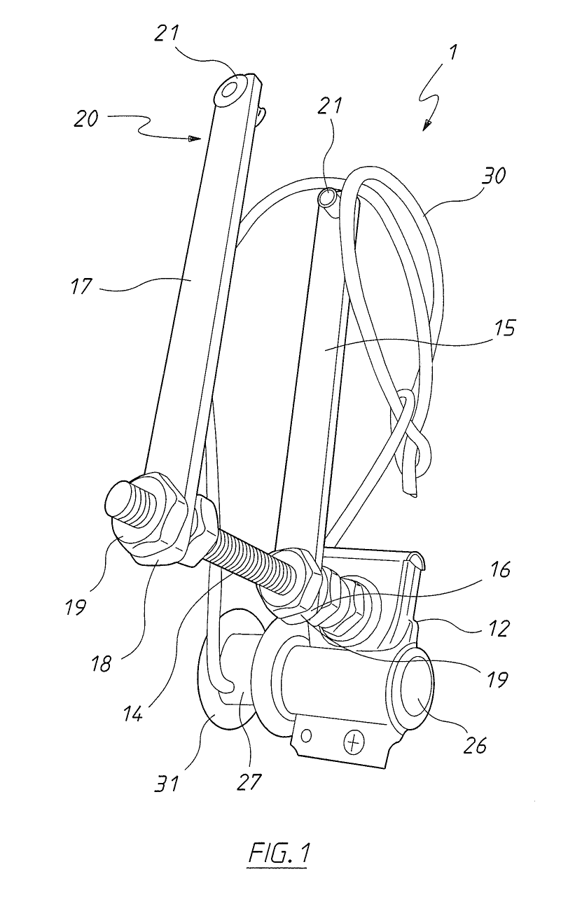

As best seen in FIG. 1, the assembly 1 includes a housing 12 to be located adjacent the lintel 8, a shaft 14 to extend away from the housing 12 and parallel to the lintel 8 and the top member 11 of the window sash 5. A first arm 15 is pivotally connected at a fixed end 16 to the shaft 14 adjacent the housing 12 and a second arm 17 pivotally connected at a fixed end 18 to the shaft 14 remote the housing 12. The arms 15, 17 can be fixed in any typical way. For example, as seen in FIG. 3 the shaft 14 could be threaded and the fixed ends 16, 18 could include a threaded hole to screw onto the shaft 14 and be held in place by fastening means such as nuts 19 or the like. Each arm 15, 17 in use is located substantially adjacent a separate jamb 7 and is substantially parallel to each other. Each arm 15, 17 includes a free end 20 having a portion 21 such as a rivet, bolt, mound, protrusion or the like engagable with a corresponding guide 25 formed in the vertical side 10 of the sash 5. In the preferred form and as best seen in FIG. 4, the vertical guides 25 extend towards the halfway of the vertical sides 10 and form a slot or the like.

The assembly 1 further includes means 26 to rotate the shaft 14. The means 26 includes a second shaft 27 locatable perpendicular to the first shaft 14 and operatively associated therewith to rotate the first shaft 14 upon movement of the second shaft 27. In the preferred form, a cord 30 or the like protrudes from the jamb 7 and when urged by a user rotates the shaft 27. The shaft 27 could include a portion 31 to hold the cord 30 when not in use.

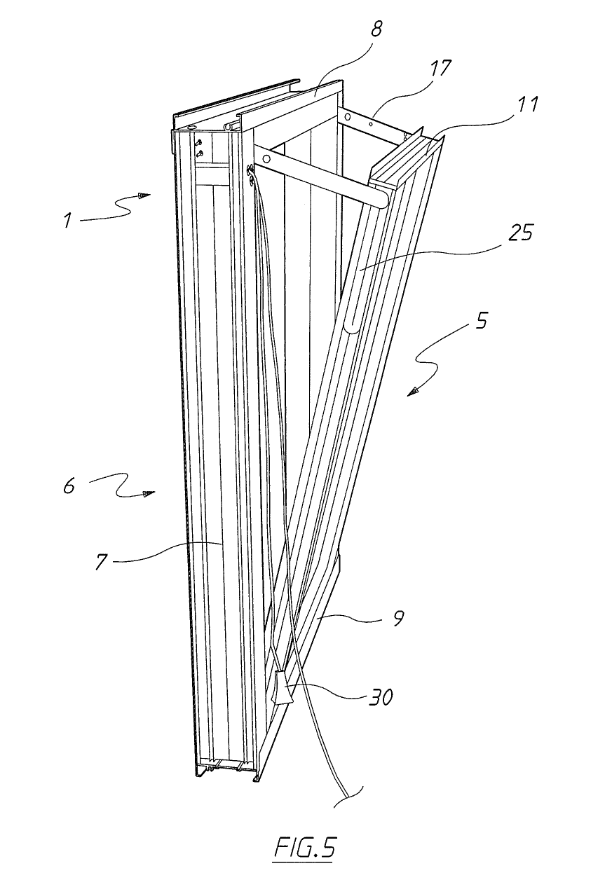

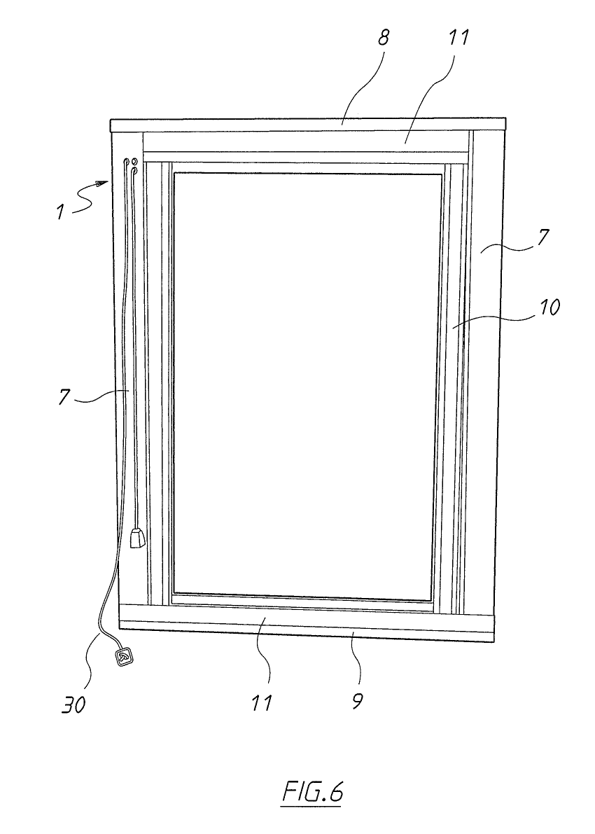

In use and as best seen FIGS. 4 to 6, to clean the outside of a window pane, the displacement assembly 1 can be utilised to temporarily displace the sash 5 from the window frame 6. FIG. 6 shows the window assembly 1 in a closed position with the cord 30 extending from the jamb 7 and housing 12. In this configuration the arms 15, 17 are positioned substantially vertically downwards and parallel to the jamb 7 and slot 25. By pulling the cord 30, the user rotates the shaft 27 and thereby shaft 14 to urge the protrusions 21 along the slot 25 from a lower position towards the middle of the sash 5 towards the top member 11 of sash 5. As the arms 15, 17 move from the vertical to the horizontal (where they are substantially perpendicular to the shaft 14), they urge the top member 11 of the sash 5 away from the lintel 8 and out of engagement with the frame 6 as best seen in FIG. 5. In this position, the lower member of the sash 5 is still located within the frame 6 at the sill 9. To complete the operation, a user lifts the sash 5 vertically upwardly to move the lower portion 11 of the sash 5 out of engagement with the sill 9 as best seen in FIG. 4. Thus the window sash 5 and window pane (not shown) are now easily accessible internally of the building and can be cleaned in a safe manner prior to reinstalling.

Although the invention has been described with reference to specific examples, it will be appreciated by those skilled in the art that the invention may be embodied in many other forms.

What is claimed is:

1. A window displacement assembly to displace a window sash from a window frame, the frame having a pair of parallel vertically extending jambs spaced apart by a horizontally extending lintel and a horizontally extending sill to define a generally rectangular window frame; said assembly including:
a housing located adjacent said lintel;
a shaft to extend away from said housing and parallel to said lintel and a top of said window sash;
a first arm pivotally connected at a fixed end to said shaft adjacent said housing;
a second arm pivotally connected at a fixed end to said shaft remote said housing;
each arm being located substantially adjacent a separate jamb and having a free end, each said free end having a portion engageable with a corresponding guide formed in vertical sides of said sash;
means to rotate said shaft;
whereby in use rotation of said shaft moves said free ends of said aims within said guides to urge said top of said sash to move away from said lintel to disengage said sash from said frame to provide access to both sides of a window pane located within the sash.

2. The window displacement assembly according to claim 1, wherein said shaft is a first shaft and wherein said means includes a second shaft locatable perpendicular to said first shaft and operatively associated therewith to rotate said first shaft upon movement of said second shaft.

3. The window displacement assembly according to claim 1, wherein said rotation means includes a cord extending from said housing which when urged by a user rotates said second shaft.

4. The window displacement assembly according to claim 1, wherein said housing is located within one said jamb.

5. The window displacement assembly according to claim 1, wherein said guides are longitudinal slots that extend along a length of said sides of said sash.

6. The window displacement assembly according to claim 1, wherein the sash surrounds a pane of glass.

7. The window displacement assembly according to claim 2, including motor means to rotate said second shaft.

8. The window displacement assembly according to claim 1, wherein said portions of said arms are rivets.

9. The window displacement assembly according to claim 1, wherein in use said arms are urged from a position parallel to said respective jambs to a position substantially perpendicular to said jambs.

10. A method of displacing a window sash from a window frame, the window frame having a pair of parallel vertically extending jambs spaced apart by a horizontally extending lintel and a horizontally extending sill to define a generally rectangular window frame, the method including the steps of:
a user pulling a cord to rotate a shaft located adjacent said lintel;
said shaft upon rotation moving a pair of arms between a first position where said arms are substantially parallel to said jamb and a second position where said arms are substantially perpendicular to said jamb;
movement of said arms between said first and second positions urges protrusions located at a free end of said arms along slots located in said sash to move a top portion of said sash away from said lintel and out of engagement with said frame to provide a user access to both sides of a window pane located within said sash.
